(19) United States
(12) Patent Application Publication
(10) Pub. No.: US 2013/0145957 A1
(43) Pub. Date: Jun. 13, 2013

(54) CORROSION INHIBITING PIGMENTS AND METHODS FOR PREPARING THE SAME

(71) Applicant: Max-Planck-Gesellschaft zur Förderung der Wissenschaften e.V., Munchen (DE)

(72) Inventors: Dmitry Shchukin, Berlin (DE); Dmitry O. Grigoriev, Berlin (DE); Helmuth Möhwald, Bingen (DE)

(73) Assignee: Max-Planck-Gesellschaft zur Förderung der Wissenschaften e.V., Munchen (DE)

(21) Appl. No.: 13/706,769

(22) Filed: Dec. 6, 2012

(30) Foreign Application Priority Data
Dec. 12, 2011 (EP) 11009781.3

(51) Int. Cl. C09D 7/00

(52) U.S. Cl. CPC C09D 7/007
USPC 106/14.05; 106/409; 106/15.05

(57) ABSTRACT

A pigment includes reservoirs of encapsulated corrosion inhibitors and/or biocides for active corrosion and/or antifouling protection of metallic and polymeric products and structures, wherein the reservoirs have average dimensions of 10-50000 nm and comprise a porous surface/interface, a porous or empty interior and stimuli-sensitive stoppers that release an encapsulated inhibitor or biocide outside the reservoir upon action of a stimulus selected from the group consisting of an external electromagnetic field, changes in local pH, ionic strength and ambient temperature, wherein the stimuli-sensitive stoppers result from a chemical or physical interaction between encapsulated corrosion inhibitor and/or biocide or encapsulated solvent/dispersing agent and an additional external compound and prevent release of an encapsulated inhibitor or biocide towards an exterior of the reservoir in the absence of the stimulus.

### RELATED APPLICATION

This application claims priority of European Patent Application No. 11009781.3, filed Dec. 12, 2011, the subject matter of which is incorporated herein by reference.

### TECHNICAL FIELD

This disclosure relates to corrosion inhibiting pigments and methods for preparing such pigments.

### BACKGROUND

Corrosion of metals is one of the main destruction processes of metallic structures leading to huge economic losses. Commonly, polymer coating systems are applied on the metal surface which provide a dense barrier for the corrosive species to protect metal structures from the corrosion attack. When the barrier is damaged and the corrosive agents penetrate to the metal surface the coating system is not able to stop the corrosion process. A rather effective solution for active protection of metals is to employ chromate-containing conversion coatings. However, hexavalent chromium species can be responsible for several diseases including DNA damage and cancer, which is the main reason for banning Cr⁶⁺-containing anticorrosion coatings in Europe since 2007.

Organically modified silicates are hybrid organic-inorganic materials formed through hydrolysis and condensation of organically modified silanes with traditional alkoxide precursors and can be used as an alternative to the traditional anticorrosion coatings based on Cr VI (C. J. Lund, P. D. Murphy, M. V. Plat, Silane and Other Coupl. Agents. 1992, 1, 423; S. H. Cho, H. M. Andersson, S. R. White, N. R. Sottos, P. V. Braun, Adv. Mater. 2006, 18 997; K. Bonnel, C. Le Pen, N. Peabeare, Electroch. Act. 1999, 44, 4259).

Another approach to prevent corrosion propagation on metal surfaces is its suppression using physical-chemical reactions of corrosion to initiate of inhibitor activity. The corrosion process itself can be a stimulus triggering the release of a healing component (e.g., inhibitors) from the coating. A few coatings with so-called “self-healing” effect have been explored (D. G. Shchukin, S. V. Lamaka, K. A. Yasakau, M. L. Zheludkevich, M. G. S. Ferreira, H. Mohwald, J. Phys. Chem. C. 2008, 112, 958). Ion-exchange resins can release inhibitors in response to reactions with corrosive ions (M. L. Zheludkevich, R. Serra, M. F. Montemor, M. G. S. Ferreira, Electrochem. Commun. 2005, 7, 836). Monomer-filled capsules introduced into polymer coatings are capable of healing defects in the coating by releasing encapsulated monomer followed by polymerization and sealing of the defective area (S. R. White, N. R. Sottos, P. H. Geubelle, J. S. Moore, M. R. Kessler, S. R. Sriram, E. N. Brown, S. Viswanathan, Nature. 2001, 409, 794).

U.S. Pat. No. 5,705,191 relates to a method for releasing an active agent into a use environment, by disposing the active agent within the lumen of a population of tubules with a preselected release profile. The preselected release profile may be achieved by controlling the length or length distribution of the tubules or by placing degradable endcaps over some or all of the tubules in the population.

EP 06 004 993.9 discloses a corrosion inhibiting pigment composed of nanoscale reservoirs which comprise a polymer or polyelectrolyte shell which is sensitive to a specific trigger, and are capable of releasing the inhibitor after action of the trigger, e.g., a change of pH induced by corrosion events.

However, even the sophisticated “self-healing” anti-corrosive coatings most recently developed are still improvable with respect to some properties such as the speed of healing a defect in response to a corrosion event and the efficiency of a controlled release of corrosion inhibitor. Moreover, it is very desirable to have active multifunctional pigments and/or coatings which provide not only corrosion protection, but also protection against adhesion and propagation of organisms, in particular algae, fungi and microoroganisms, on a broad range of surfaces, including metallic and polymeric surfaces.

Thus, there is a need to provide effective and broadly applicable means for providing active corrosion and anti-fouling protection, in particular with self-healing ability, which improve long-term performance of metallic and polymeric substrates.

### SUMMARY

We provide a pigment including reservoirs of encapsulated corrosion inhibitors and/or biocides for active corrosion and/or antifouling protection of metallic and polymeric products and structures, wherein the reservoirs have average dimensions of 10-50000 nm and include a porous surface/interface, a porous or empty interior and stimuli-sensitive stoppers that release an encapsulated inhibitor or biocide outside the reservoir upon action of a stimulus selected from the group consisting of an external electromagnetic field, changes in local pH, ionic strength and ambient temperature, wherein the stimuli-sensitive stoppers result from a chemical or physical interaction between encapsulated corrosion inhibitor and/or biocide or encapsulated solvent/dispersing agent and an additional external compound and prevent release of an encapsulated inhibitor or biocide towards an exterior of the reservoir in the absence of the stimulus.

We also provide a method of preparing the pigment including reservoirs of encapsulated corrosion inhibitors and/or biocides for active corrosion and/or antifouling protection of metallic and polymeric products and structures, wherein the reservoirs have average dimensions of 10-50000 nm and include a porous surface/interface, a porous or empty interior and stimuli-sensitive stoppers that release an encapsulated inhibitor or biocide outside the reservoir upon action of a stimulus selected from the group consisting of an external electromagnetic field, changes in local pH, ionic strength and ambient temperature, wherein the stimuli-sensitive stoppers result from a chemical or physical interaction between encapsulated corrosion inhibitor and/or biocide or encapsulated solvent/dispersing agent and an additional external compound and prevent release of an encapsulated inhibitor or biocide towards an exterior of the reservoir in the absence of the stimulus, including a) providing reservoirs with average dimensions of 10-50000 nm and having a porous surface/interface and a porous or empty interior; b) introducing corrosion inhibitor and/or biocide into the reservoirs; c) contacting the corrosion inhibitor and/or biocide containing reservoirs after step b) with at least one external compound that reacts with the corrosion inhibitor and/or biocide or the solvent/dispersing agent that introduces the inhibitor or biocide into the reservoir; and d) reacting the external compound with the corrosion inhibitor and/or biocide or the solvent/dispersing agent to introduce the inhibitor or biocide to form stimulus-sensitive stoppers at the interface between a bulk medium surrounding the reservoir and containing the external compound and outer ends of pores of the reservoir.

We further provide a method of preventing or inhibiting corrosion or fouling of a metal or polymer product or structure including incorporation of the pigment including reservoirs of encapsulated corrosion inhibitors and/or biocides for active corrosion and/or antifouling protection of metallic and polymeric products and structures, wherein the reservoirs have average dimensions of 10-50000 nm and include a porous surface/interface, a porous or empty interior and stimuli-sensitive stoppers that release an encapsulated inhibitor or biocide outside the reservoir upon action of a stimulus selected from the group consisting of an external electromagnetic field, changes in local pH, ionic strength and ambient temperature, wherein the stimuli-sensitive stoppers result from a chemical or physical interaction between encapsulated corrosion inhibitor and/or biocide or encapsulated solvent/dispersing agent and an additional external compound and prevent release of an encapsulated inhibitor or biocide towards an exterior of the reservoir in the absence of the stimulus into pre-treatments, primers, top coats, formulations of polymer coatings, powder coatings, paints and concretes.

### BRIEF DESCRIPTION OF THE DRAWING

FIG. 1 is a schematic illustration of two alternatives of the reservoirs used in our pigments, (I) porous particle scaffold, (II) porous core-shell system.

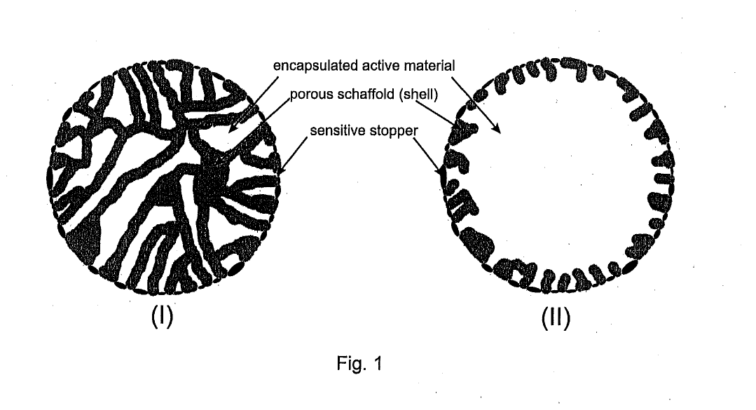

### DETAILED DESCRIPTION

It will be appreciated that the following description is intended to refer to specific examples of structure selected for illustration in the drawing and is not intended to define or limit the disclosure, other than in the appended claims.

The pigment comprises reservoirs of encapsulated corrosion inhibitors and/or biocides for active corrosion and/or antifouling protection of metallic and polymeric products and structures, wherein the reservoirs have average dimensions of 10-50000 nm comprise a porous surface/interface and a porous or empty interior and stimuli-sensitive stoppers capable of releasing an encapsulated inhibitor or biocide outside the reservoir upon action of a stimulus selected from the group consisting of an external electromagnetic field, changes in local pH, ionic strength and ambient temperature, wherein the stimuli-sensitive stoppers are the result from a chemical or physical interaction between encapsulated corrosion inhibitor and/or biocide or solvent/dispersing agent and an additional external compound and prevent the release of an encapsulated inhibitor or biocide towards the reservoir exterior in the absence of the stimulus.

As already mentioned above, the specific trigger or stimulus which causes the stoppers to release the active compound enclosed or incorporated therein may be any one of several stimuli to which the specific stopper material is known to be responsive. Typical stimuli are a change of pH, ionic strength, temperature, humidity or water, light, mechanical stress, or magnetic or electromagnetic fields. A preferred stimulus is a change of pH or electromagnetic radiation.

The use of electromagnetic radiation enables the reservoirs to locally open in parts of the coating damaged by the corrosion process while the other intact part of the coating remains closed. In this method, the area of the opening may be determined by the irradiation focus and/or the release of loaded material may be regulated by the dose and intensity of irradiation.

Typically, the kind of irradiation is selected from UV, visible or IR irradiation and preferably the electromagnetic irradiation involves a laser irradiation. Generally, the wavelength for UV irradiation is 200 nm to 400 nm, the wavelength for visible light irradiation is 400 nm to 800 nm and the IR wavelength is 800 nm to 3500 nm. The intensity of irradiation may vary over a broad range, i.e., depending on the specific coating and container materials and wavelength of the electromagnetic radiation used.

In the pigment, the stimuli-sensitive stoppers are preferably situated at the outer end of pores in a porous reservoir scaffold or in pores of a reservoir shell.

More specifically, the reservoirs with a porous or empty interior comprise mesoporous or microporous oxide, nitride, carbide or fluoride particles, halloysites, mineral clays, zeolites, layered double hydroxides (LDH), carbon nanotubes, meso- and microporous carbon materials, polymer gels and core-shell oxide, nitride, carbide or fluoride materials with empty inner interior and porous shell.

In particular, if the reservoir comprises a porous shell, the shell may be composed of any inorganic or organic material which, apart from the pores is essentially impermeable for the active compound(s) and solvent(s) and/or dispersing agents, if any, used to introduce the active material into the reservoirs. More specifically, the shell is composed of a material selected from the group comprising mesoporous or microporous oxides, halloysites, clays, zeolites, layered double hydroxides (LDH), carbon nanotubes and polymer gels.

Typically, the reservoirs have a mean diameter of 10 nm to 50 μm, preferably 20 nm to 5 μm, more preferred 50 nm to 500 nm. Preferably the particles are mesoporous, having a mean pore size of 1 nm to 200 nm.

Generally, the lower size of the pores is limited by the size of the molecule of corrosion inhibitor or biocide to be incorporated into the pores.

The corrosion inhibitor to be stored in the reservoirs of the pigment may be any known corrosion inhibitor suitable for the intended purpose. The choice of the inhibitor will depend, i.e., from the specific metallic products and structures to be protected, from the environmental conditions and operating conditions of the corrosion-protected products and other factors which will be evident to those skilled in the art.

The corrosion inhibitor may comprise a compound selected from the group consisting of an organic compound containing one or more amino groups, an azole compound or a derivative thereof, a thiazole compound or a derivative thereof, an imidazole compound or a derivative thereof, an organic compound containing one or more carboxyl groups or salts of carboxylic acids, an organic compound containing one or more pyridinium or pyrazine groups, one or more Schiff bases, benzotriazole, mercaptobenzothiazol, quinoline, quinaldic acid or quinolinol, H₂TiF₆ acid and its derivatives, phosphates, nitrites, silicates, molybdates, borates, iodates, permanganates, tungstates, vanadates, cations of one or more metals selected from the group comprising lanthanides, magnesium, calcium, titanium, zirconium, yttrium, chromium and silver, alkoxysilanes and their derivatives containing amino, imino, carboxy, isocyanato, or thiocyanato groups, silyl esters, halogenated alkoxysilanes, silazanes and derivatives or blends thereof.

More specifically, the corrosion inhibitor is selected from the group comprising one or more amino groups, an azole compound or a derivative thereof, a thiazole compound or a derivative thereof, an imidazole compound or a derivative thereof, benzotriazole, mercaptobenzothiazol, quinoline, quinaldic acid or quinolinol, H₂TiF₆ acid and its derivatives, phosphates, molybdates, borates, tungstates, vanadates, cations of lanthanides.

The inhibitor may also comprise two or more compounds selected from the above specified classes of inhibitors.

The biocide to be stored in the reservoirs of the pigment may be any known biocide suitable for the intended purpose. The choice of the biocide will depend, i.e., from the specific products and structures to be protected, from the environmental conditions and operating conditions of the protected products and other factors which will be evident to those skilled in the art.

The biocide may comprise a compound selected from the group consisting of tributyltin compounds and other organotin derivatives, copper compounds, quaternary ammonium compounds (Quats), chlorothalonil, methylene bis(thiocyanate), captan, pyridiniumtriphenylboron, diuron, halogenated alkyliso-thiazolin, a substituted isothiazolone such as 4,5-dichloro-2-n-octyl-4-iso-thiazolin-3-one (DCOIT), thiuram, tetraalkyl thiuram disulfide and their derivatives, zinc oxide, zinc pyrithione, zinc ethylenebis(dithiocarbamate) (zineb), copper pyrithione, dichlorofluanid, TCMS pyridine and thiocyanomethylthio-benzothiazole (TCMTB), halogenides of trimethoxysilyl quaternary ammonium compounds (quaternary alkoxysilyl compounds), 2-methylthio-4-t-butylamino-6-cyclopropyl-amino-s-triazine (cyclobutryn, also sold as irgarol), 2-(thio-cyanomethylthio)benzothiazole, 2,4,5,6-tetrachloro-isophthalonitrile, tolylfluanid, 2,3,5,6-tetrachloro-4-(methylsulfonyl)pyridine and derivatives or blends thereof.

More specifically, the biocide may be selected from the group comprising copper compounds, quaternary ammonium compounds (Quats), captan, diuron, halogenated alkyliso-thiazolin, a substituted isothiazolone such as 4,5-dichloro-2-n-octyl-4-iso-thiazolin-3-one (DCOIT), thiuram and their derivatives, zineb, 2-methylthio-4-t-butylamino-6-cyclopropyl-amino-s-triazine, zinc or copper pyrithione, dichlorofluanid, TCMS pyridine and thiocyanomethylthio-benzothiazole (TCMTB), tolylfluanid.

The biocide may also comprise two or more compounds selected from the above specified classes of biocides.

The term “derivative” as used herein, means any compound or conjugate/aggregate of compounds comprising the basic structural element or functional group, e.g., a derivative of an azole compound may be any compound or conjugate/aggregate of compounds comprising at least one azole moiety, a derivative of H₂TiF₆ acid may be, e.g., a salt or complex thereof.

The pigment is characterized in that the stimuli-sensitive stoppers comprise the products of an interfacial chemical or physical reaction between a) an internal compound within the reservoirs which is the active compound, i.e., corrosion inhibitor and/or biocide, or a solvent and/or dispersing agent used to incorporate the inhibitor or biocide into the reservoir and b) at least one external compound.

The stimuli-sensitive stoppers may comprise the products of an interfacial chemical or physical reaction between a) encapsulated inhibitor as defined above or biocide as defined above or a solvent and/or dispersing agent used for incorporation of the inhibitor or biocide into the reservoir and b) at least one compound selected from the group consisting of ionic compounds, including metal salts and polyelectrolytes, biopolymers such as proteins, aminoacids, polysaccharides, such as casein, lactoglobulin, albumin, keratin, myosin, tubulin, collagen (gelatin), lysozyme, agarose, cellulose, alginic acid, dextran, chitosan, polyarginine, polyglycin, polyglutamic acid, polyaspartic acid, and derivatives, copolymers or blends thereof.

The stimuli-sensitive stoppers may comprise the products of an interfacial chemical or physical reaction between a) encapsulated inhibitor as defined above or biocide as defined above or a solvent and/or dispersing agent used for incorporation of the inhibitor or biocide into the reservoir and b) at least one compound selected from the group consisting of compounds having isocyanate, acrylate, cyanoacrylate, vinyl, epoxy, hydroxyl, amino, or imino moieties, polyunsaturated fatty acids, drying oils and derivatives, comonomers or blends thereof.

The products of the interfacial chemical or physical reaction may comprise an ionic complex or an aggregate which is the result of covalent interactions or non-covalent interactions such as electrostatic or van der Waal's forces between at least one component a) and at least one component b) as defined above.

The stimuli-sensitive stoppers may comprise the products of an interfacial physical process which is initiated or accelerated by the encapsulated inhibitor or biocide or a solvent and/or dispersing agent used to incorporate the inhibitor or biocide into the reservoir in interaction with at least one compound selected from the group consisting of organic polymeric nanoparticles, polymers such as polystyrene, polyacryl, polycarbonate, polyester, polyterpene, polyanhydride, polyurethane, polyamide, and derivatives, copolymers or blends thereof.

More specifically, the interfacial physical process is interfacial precipitation, coacervation, or gelation.

Preferably, the stimuli-sensitive stoppers comprise the products of the reaction of a corrosion inhibitor selected from the group of specific inhibitors from above or of a biocide selected from the group of specific biocides from above or of a solvent/dispersing agent selected from water, the group of polar water miscible solvents/dispersing agents composed of ketones, aldehydes, carboxyacids, alcohols, esters, ethers, amines, imines, imides, organometallics and their derivatives; the group of unpolar water immiscible or sparingly miscible dispersing agents composed of saturated, cyclic or unsaturated hydrocarbons, silicone oil, ketones, aldehydes, fatty carboxyacids and alcohols, esters, ethers, fatty amines, imines, imides, organometallics, with at least one external compound selected from the group consisting of ionic compounds, including metal salts and polyelectrolytes, biopolymers, compounds having isocyanate, acrylate, cyanoacrylate, vinyl, epoxy, hydroxyl, amino, or imino moieties, polyunsaturated fatty acids and derivatives, polymers such as polystyrene, polyacryl, polycarbonate, polyester, polyurethane and derivatives.

We also provide a method of preparing the pigment comprising the steps of:
a) providing reservoirs with average dimensions of 10-50000 nm having a porous surface/interface and a porous or empty interior;
b) introducing corrosion inhibitor and/or biocide into the reservoirs;
c) contacting the corrosion inhibitor and/or biocide containing reservoirs after step b) with at least one external compound capable to react with the corrosion inhibitor and/or biocide or the solvent/dispersing agent used to introduce the inhibitor or biocide into the reservoir;
d) reacting the external compound with the corrosion inhibitor and/or biocide or the solvent/dispersing agent used to introduce the inhibitor or biocide to form stimulus-sensitive stoppers at the interface between the bulk medium surrounding the reservoir and containing the external compound and the outer end of pores of the reservoir.

The chemical or physical reaction may be a polymerization, in particular a free radical polymerization, and the at least one external compound comprises one or more monomers.

Preferably, the method for preparing the pigment comprises ultra-sonification of the corrosion inhibitor and/or biocide containing reservoirs obtained in step b) or of the mixture obtained in step c). Typically, free radicals are generated in the course of the ultrasound treatment and serve as activators for a polymerization reaction.

The external compound may be provided as an oil-in-water emulsion. This emulsion may, e.g., comprise one or more monomeric reactants for a polymerization reaction.

Many corrosion inhibitors and/or biocides are simultaneously catalysts or accelerators of diverse polymerization processes. For instance, compounds from the thiurams group (see also the more specific Example 1 below) can strongly decrease the activation energy of the cross-linking reaction proceeding at the curing of artificial rubbers such as butadiene rubber, styrene-butadiene rubber, acrylonitrile butadiene styrene rubber, acrylonitrile butadiene rubber, etc. In course of this reaction, the polysulfur bridges are formed between some allyl hydrogens situated in the vicinity of double bonds in the reacting en-monomers or en-prepolymers. Being introduced into pores of the pigment particles, catalysts or accelerator compounds like thiurams form at the outer ends of these pores sites where the above mentioned polymerization reaction will preferably run making rubber stoppers preventing the filled biocides or/and inhibitors from the undesired contacts with the surrounding medium and premature release.

Thus, preferably, the stimuli-sensitive stoppers are formed by an interfacial polymerization reaction of an external compound comprising at least one en-monomer or en-prepolymer (in particular monomers or prepolymers yielding artifical rubber products) in the presence of an internal compound comprising at least one thiuram compound.

On the other side, numerous corrosion inhibitors and/or biocides are organic heterocyclic compounds carrying such atoms like oxygen, nitrogen, sulphur, phosphorus and halogens in their structure and enable formation of quite stable complexes with many ionic species (cations as well as anions) possessing low solubility products in aqueous media under normal conditions. These complexes can serve as material of the stoppers at the outer ends of pores in the pigment particles. The beginning of the corrosion process leads to the changes of the ambient conditions for these stoppers like increase or decrease of pH, occurrence of ionic products of corrosion, etc., disturbing the stability of complexes and causing their gradual or immediate dissolution. As a result, the release of inhibitor or/and biocide triggered by the onset of corrosion process takes place on demand. A particular situation realizable according this general scenario is described in details in Example 5.

Thus, preferably, the stimuli-sensitive stoppers are formed by interfacial complexation of an internal organic heterocyclic compound carrying atoms such as oxygen, nitrogen, sulphur, phosphorus and halogen with at least one external compound which is a ionic species (cations as well as anions), including metal salts and polyelectrolytes.

We further provide a method of preventing or inhibiting corrosion or fouling of a metal or polymer product or structure comprising incorporation of the pigment to pre-treatments, primers, top coats, formulations of polymer coatings, powder coatings, paints and concretes, in particular in form of a powder, paste or a suspension.

Additional anti-corrosive applications of the pigments will be evident to those skilled in the art and are encompassed by this disclosure as well.

### Example 1

A. Mesoporous silica (SiO₂) nanoparticles were impregnated by a saturated solution of the mixed biocides tetrabenzyl thiuram disulfide (TBzTD) and tetramethylthiuram disulfide (TMTD) in toluene saturated previously by sulfur acting also as a broad spectrum biocide. Impregnated nanoparticles were dried in a vacuum to remove the solvent. After that, the dry particles were quickly rinsed by toluene to remove the possible sediment of mixture rested on the particle surface sites around the pores and dried again. Then, silica nanoparticles were dispersed in the aqueous medium (5 wt/v % suspension) by means of non-ionic polymeric surfactant polyvinyl alcohol (PVA, Mw=8000-9000, 80% hydrolyzed, Sigma-Aldrich, 1 wt % solution).
B. A second mixture consisting of 1 v/v % oil-in-water emulsion of 2-propenenitrile, 1,3-butadiene, and 1,2-butadiene in the 1 wt % aqueous solution of PVA (see above) was prepared.
C. The oil-in-water emulsion prepared on the step B was then dropwise added to the aqueous suspension of impregnated silica prepared in step A under continuous ultrasound treatment of the entire mixture.
D. Free radicals generated in course of ultrasonication of mixture served as activators for the polymerization reaction yielding the Nitrile butadiene rubber pre-polymers. During intensive stirring of the mixture induced also by ultrasonication, numerous collisions of impregnated silica nanoparticles with the emulsion droplets took place. Outer ends of pores filled by the mixture of thiurams and sulfur (see above, step A) formed patches on the particles surface that act as fast-curing ultra accelerators for the Nitrile butadiene rubber polymers (specific curing ability of thiurams class of compounds). This spatially benefited curing process driven by ultrasound energy formed the stoppers at the end of each pore and, thus, sealed the encapsulated thiurams inside of mesoporous silica carriers. The obtained containers were separated by centrifugation, washed first by toluene and then three times by MilliQ water under neutral pH conditions and resuspended in aqueous medium by PVA.

Because of the specific sensitivity of short Nitrile butadiene rubber polymer in the stoppers to strong to medium acidic environment and to UV-radiation, these factors could be used as particular triggers to open the stoppers on demand.

### Example 2

A. Oil-soluble corrosion inhibitor stearoyl sarcosine (available as for example Hamposyl S from Hampshire) was dissolved in a Linseed oil forming 10 wt % solution.
B. 100 g hydrophobically modified silica porous microparticles (for instance, Syloid® C 906 from GRACE) were impregnated with 200 g of oil solution prepared in step A.
C. 5 wt %/v % rough suspension of silica particles obtained on step B in aqueous 0.5 wt % solution of Pluronic 123 was prepared using a rotor-stator high speed homogenizer at 16 Krpm for 5 minutes.
D. 200 ml rough suspension prepared in step C was treated by intensive ultrasound, and upon continuous sonication 5 ml 0.5 wt % aqueous solution of hexaamminecobalt(III) nitrate were added dropwise to the reaction mixture. Free radicals generated in course of ultrasonication of mixture caused the polymerization of polyunsaturated fatty acid in linseed oil catalyzed additionally by Co(III) ions. This polymerization can take place however only at the interface between outer ends of pores in the silica microparticles used and surrounding aqueous medium because of mutual immiscibility of free radical compounds and catalyst from water phase and polyunsaturated fatty acid containing in the oil. As a result, the stoppers at the pores outer ends were formed, encapsulating the oil-soluble corrosion inhibitor stearoyl sarcosine in the silica microparticle carriers.

Because of the specific sensitivity of polyolefin acidic stoppers to media with high pH values, a transition to pH ranges above 10 results in the stoppers dissolution and inhibitor release. The triggering effect of high pH is revealed by deprotonation of stearoyl sarcosine in this range and subsequent sharp increase of its solubility.

### Example 3

A. 80 g mesoporous carbon microparticles were impregnated by with 20 g trichlorooctadecyl silane (TCOS) and 60 g trimethoxyoctyl silane (TMOcS) acting as water-repelling and anticorrosive agents. After impregnation, the particles were quickly rinsed with chloroform to remove possible excess of TCOS and TMOcS from the particle surface sites around the pores and dried.
B. 20 g tetramethoxy silane (TMOS) were added to 100 ml MilliQ water at pH 5 and stirred for 60 minutes until hydrolysis of TMOS was completed.
C. To the mixture prepared in step B, the amount of non-ionic surfactant Triton X-100 needed for preparation of 0.5 wt % solution of surfactant was added and completely dissolved under mild stirring.
D. The pH of mixture prepared in step C was very quickly enhanced to the value above 12 by addition of small amounts of concentrated NaOH solution.
E. Immediately after step D, the impregnated carbon microparticles were rapidly added to the mixture prepared in step D and mixed very vigorously by high speed homogenizer at 13.5 Krpm for 10 minutes.
F. Due to the very fast hydrolysis of TCOS at the outer end of pores in the carbon microparticles and due to subsequent condensation of pre-hydrolyzed of TMOS on these sites, the silica-stoppers were formed and sealed the encapsulated mixture of water-repelling and anticorrosive agents TCOS and TMOcS inside microparticulate carbon carriers.

An increase in the medium's pH as a consequence of corrosion process development to the range above 11 can cause an increase of the negative charge of microporous carbon scaffold and, therefore, a strong electrostatic repulsion between the scaffold and stoppers also possessing a high negative charge at this pH. Thus, pH-enhancement over 11 in the medium can act as a trigger for inhibitor release. Another release trigger can be a simple mechanical breakdown of the carbonaceous microcarriers.

### Example 4

A. Mesoporous titania (TiO₂) microparticles were repeatedly impregnated by the corrosion inhibitor ammonium heptamolybdate tetrahydrate (AM) from its saturated solution in dimethylsulfoxide (DMSO) and then dried in vacuum to remove excess of solvent. After that, the dry particles were quickly rinsed by DMSO to remove the possible sediment of AM rested on the particle surface sites around the pores and dried again.
B. 0.5 wt % solution of sodium docusate (AOT) in Diethylbenzene was prepared under continuous moderate stirring at room temperature.
C. 10 g powder of mesoporous titania microparticles impregnated by AM in step A, were dispersed in the 100 ml organic medium prepared in step B under vigorous stirring by high speed homogenizer at 16 Krpm for 10 minutes.
D. 5 ml of 5 wt % solution of ethyl cyanoacrylate in Diethylbenzene were added dropwise to 50 ml suspension obtained in step C.
E. After addition was completed, the temperature of mixture prepared in step D was gradually enhanced to 90° C. This temperature caused the loss of water molecules from crystalohydrate AM and causes the polymerization reaction of ethyl cyanoacrylate at the outer ends of pores in the titania carries because of diffusion of liberated water molecules toward the solid-organic medium interface. As a result, the polymeric cyanoacrylate stoppers at the end of these pores were formed sealing the AM inhibitor inside the microscale titania carriers.

Because of the low stability of cyanoacrylate polymers at high pH values, the increase of this value due to local corrosion development is able to cause the pH-triggered release of corrosion inhibitor.

### Example 5

A. Mesoporous titania (TiO₂) microparticles were impregnated by the saturated solution of corrosion inhibitor and biocide 8-hydroxyquinoline (8-HQ) in chloroform. After solvent evaporation, the dry particles were quickly rinsed by chloroform to remove the possible sediment of 8-HQ rested on the particle surface sites around the pores and dried again. Then, titania microparticles were dispersed in the aqueous medium as 5 wt/v % suspension by means of non-ionic polymeric surfactant polyvinyl alcohol (PVA, Mw =8000-9000, 80% hydrolyzed, Sigma-Aldrich, 1 wt % solution) in the neutral pH range between 5 and 8, better between 6.5 and 7.5.
B. 1000 ml of 10 wt % Ca(NO₃)₂.4H₂O solution in MilliQ water was prepared in the beaker under continuous stirring and mild heating upon full dissolution of salt. The pH of this solution was adjusted to value 5.
C. 100 ml of suspension prepared in step A were added dropwise and under vigorous stirring to the solution prepared in step B. Due to equal charge of titania particles surface and Ca²⁺ cations on the one hand and due to low solubility of complex between Ca²⁺ cations and molecules of 8-HQ in the pH window used, the stoppers made of this complex were formed explicitly at outer ends of pores whereas the titania surface around them remained uncovered. These complexes seal the encapsulated 8-HQ in the interior of microparticulate titania carriers. The obtained containers were separated by centrifugation, washed three times by MilliQ water under neutral pH conditions and resuspended in aqueous medium by means of PVA.

Due to specific sensitivity of Ca²⁺/8-HQ complexes in the stoppers to strong acidic and basic pH values, increase or decrease of pH during the corrosion development could be used as trigger for the on demand opening of stoppers. Moreover, because of the much lower solubility of 8-HQ complexes with other metal cations that may occur as corrosion products (Fe³⁺, Zn²⁺, Al³⁺, Cd²⁺, Cu²⁺), the Ca²⁺/8-HQ complexes in the stoppers can be easily dissolved by these specific triggers too and open the pores for the free release of 8-HQ inhibitor.

1. A pigment comprising reservoirs of encapsulated corrosion inhibitors and/or biocides for active corrosion and/or antifouling protection of metallic and polymeric products and structures, wherein the reservoirs have average dimensions of 10-50000 nm and comprise a porous surface/interface, a porous or empty interior and stimuli-sensitive stoppers that release an encapsulated inhibitor or biocide outside said reservoir upon action of a stimulus selected from the group consisting of an external electromagnetic field, changes in local pH, ionic strength and ambient temperature, wherein said stimuli-sensitive stoppers result from a chemical or physical interaction between encapsulated corrosion inhibitor and/or biocide or encapsulated solvent/dispersing agent and an additional external compound and prevent release of an encapsulated inhibitor or biocide towards an exterior of the reservoir in the absence of said stimulus.

2. The pigment according to claim 1, wherein the stimuli-sensitive stoppers are situated at outer ends of pores in a porous reservoir scaffold or in pores of a reservoir shell.

3. The pigment according to claim 1, wherein the reservoirs with porous or empty interior comprise mesoporous or microporous oxide, nitride, carbide or fluoride particles, halloysites, mineral clays, zeolites, layered double hydroxides (LDH), carbon nanotubes, meso- and microporous carbon materials, polymer gels and core-shell oxide, nitride, carbide or fluoride materials with empty inner interior and porous shell.

4. The pigment according to claim 1, wherein the corrosion inhibitor comprises a compound selected from the group consisting of an organic compound containing one or more amino groups, an azole compound or derivative thereof, a thiazole compound or derivative thereof, an imidazole compound or derivative thereof, an organic compound containing one or more carboxyl groups or salts of carboxylic acids, an organic compound containing one or more pyridinium or pyrazine groups, one or more Schiff bases, benzotriazole, mercaptobenzothiazol, quinoline, quinaldic acid or quinolinol, H₂TiF₆ acid and its derivatives, phosphates, nitrites, silicates, molybdates, borates, iodates, permanganates, tungstates, vanadates, cations of one or more metals selected from the group consisting of lanthanides, magnesium, calcium, titanium, zirconium, yttrium, chromium and silver, alkoxysilanes and their derivatives containing amino, imino, carboxy, iso-cyanato, or thiocyanato groups, silyl esters, halogenated alkoxysilanes, silazanes and their derivatives and blends thereof.

5. The pigment according to claim 1, wherein the biocide comprises a compound selected from the group consisting of tributyltin compounds and other organotin derivatives, copper compounds, quaternary ammonium compounds, chlorothalonil, methylene bis(thiocyanate), captan, pyridiniumtriphenylboron, diuron, halogenated alkylisothiazolin, a substituted isothiazolone such as 4,5-dichloro-2-n-octyl-4-iso-thiazolin-3-one (DCOIT), thiuram, tetraalkyl thiuram disulfide and their derivatives, zinc oxide, zinc pyrithione, zinc ethylenebis(dithiocarbamate) (zineb), copper pyrithione, dichlorofluanid, TCMS pyridine and thiocyanomethylthio-benzothiazole (TCMTB), halogenides of trimethoxysilyl quaternary ammonium compounds (quaternary alkoxysilyl compounds), 2-methylthio-4-t-butylamino-6-cyclopropyl-amino-s-triazine (irgarol), 2-(thio-cyanomethylthio)benzothiazole, 2,4,5,6-tetra-chloro-isophthalonitrile, tolylfluanid, 2,3,5,6-tetra-chloro-4-(methyl-sulphonyl)pyridine and derivatives or blends thereof.

6. The pigment according to claim 1, wherein the stimuli-sensitive stoppers comprise products of an interfacial chemical or physical reaction between a) the encapsulated inhibitor or the biocide or a solvent/dispersing agent to incorporate the inhibitor or biocide into the reservoir and b) at least one compound selected from the group consisting of ionic compounds including metal salts and polyelectrolytes, biopolymers including proteins, aminoacids, polysaccharides including casein, lactoglobulin, albumin, keratin, myosin, tubulin, collagen (gelatin), lysozyme, agarose, cellulose, alginic acid, dextran, chitosan, polyarginine, polyglycin, polyglutamic acid, polyaspartic acid, and derivatives, copolymers or blends thereof.

7. The pigment according to claim 1, wherein the stimuli-sensitive stoppers comprise the products of an interfacial chemical or physical reaction between a) the encapsulated inhibitor or the biocide or a solvent/dispersing agent to incorporate the inhibitor or biocide into the reservoir and b) at least one compound selected from the group consisting of compounds having iso-cyanate, acrylate, cyanoacrylate, vinyl, epoxy, hydroxyl, amino, or imino moieties, polyunsaturated fatty acids, drying oils and derivatives, comonomers or blends thereof.

8. The pigment according to claim 6, wherein the products of said interfacial chemical or physical reaction comprise an ionic complex or an aggregate resulting from covalent interactions or non-covalent interactions including electrostatic or van der Waal's forces between at least one of component a) and at least one of component b).

9. The pigment according to claim 7, wherein the products of said interfacial chemical or physical reaction comprise an ionic complex or an aggregate resulting from covalent interactions or non-covalent interactions including electrostatic or van der Waal's forces between at least one of component a) and at least one of component b).

10. The pigment according to claim 1, wherein the stimuli-sensitive stoppers comprise products of an interfacial physical process initiated or accelerated by the encapsulated inhibitor or biocide or a solvent/dispersing agent that incorporates the inhibitor or biocide into the reservoir in interaction with at least one compound selected from the group consisting of organic polymeric nanoparticles, polymers including polystyrene, polyacryl, polycarbonate, poly-ester, polyterpene, polyanhydride, polyurethane, polyamide, and derivatives, copolymers or blends thereof.

11. The pigment according to claim 10, wherein the interfacial physical process is interfacial precipitation, coacervation, or gelation.

12. A method of preparing the pigment according to claim 1, comprising:
a) providing reservoirs with average dimensions of 10-50000 nm and having a porous surface/interface and a porous or empty interior;
b) introducing corrosion inhibitor and/or biocide into the reservoirs;
c) contacting the corrosion inhibitor and/or biocide containing reservoirs after step b) with at least one external compound that reacts with the corrosion inhibitor and/or biocide or the solvent/dispersing agent that introduces the inhibitor or biocide into the reservoir;
d) reacting the external compound with the corrosion inhibitor and/or biocide or the solvent/dispersing agent to introduce the inhibitor or biocide to form stimulus-sensitive stoppers at the interface between a bulk medium surrounding the reservoir and containing said external compound and outer ends of pores of the reservoir.

13. The method according to claim 12, which comprises ultrasonification of the corrosion inhibitor and/or biocide containing reservoirs obtained in step b) or of the mixture obtained in step c).

14. The method according to claim 12, wherein the chemical or physical reaction is a free radical polymerization, and the at least one external compound comprises one or more monomers.

15. The method according to claim 12, wherein the external compound is provided as an oil-in-water emulsion.

16. A method of preventing or inhibiting corrosion or fouling of a metal or polymer product or structure comprising incorporation of the pigment according to claim 1 into pre-treatments, primers, top coats, formulations of polymer coatings, powder coatings, paints and concretes.

17. The method according to claim 16, wherein the pigment is a powder, paste or a suspension.
